(19) United States
(12) Patent Application Publication
(10) Pub. No.: US 2025/0372662 A1
(43) Pub. Date: Dec. 4, 2025

(54) CURRENT COLLECTOR FOR BIPOLAR BATTERY, AND BIPOLAR BATTERY

(71) Applicant: TOYOTA JIDOSHA KABUSHIKI KAISHA, Toyota-shi (JP)

(72) Inventors: Shinji KOJIMA, Nagoya-shi (JP); Takahiko NAKANO, Nagoya-shi (JP); Yusuke KINTSU, Miyoshi-shi (JP); Hirokazu TAKEUCHI, Toyota-shi (JP)

(73) Assignee: TOYOTA JIDOSHA KABUSHIKI KAISHA, Toyota-shi (JP)

(21) Appl. No.: 19/040,193

(22) Filed: Jan. 29, 2025

(30) Foreign Application Priority Data
Jun. 4, 2024 (JP) 2024-090731

(51) Int. Cl. H01M 4/70; H01M 4/36; H01M 10/0525

(52) U.S. Cl. CPC H01M 4/70; H01M 4/366; H01M 10/0525

(57) ABSTRACT

In the current collector for a bipolar battery of the present disclosure, the first current collector and the second current collector are bonded to each other via a conductive adhesive layer, the first current collector is provided with a first through hole, the conductive adhesive layer is inserted into the first through hole, and/or the second current collector is provided with a second through hole, and the conductive adhesive layer is inserted into the second through hole. In the bipolar battery of the present disclosure, the first electrode active material layer is bonded to the current collector for the bipolar battery by the conductive adhesive layer that has entered the first through hole, and/or the second electrode active material layer is bonded to the current collector for the bipolar battery by the conductive adhesive layer that has entered the second through hole.

### CROSS-REFERENCE TO RELATED APPLICATION

This application claims priority to Japanese Patent Application No. 2024-090731 filed on Jun. 4, 2024, incorporated herein by reference in its entirety.

### BACKGROUND

### 1. Technical Field

The present disclosure relates to a current collector for a bipolar battery, and to the bipolar battery.

### 2. Description of Related Art

Japanese Unexamined Patent Application Publication No. 2020-109762 (JP 2020-109762 A) and Japanese Unexamined Patent Application Publication No. 2017-073374 (JP 2017-073374 A) disclose bipolar lithium-ion batteries. Bipolar lithium-ion batteries include a battery element including a cathode layer, an anode layer, one or more bipolar electrode layers that are disposed between the cathode layer and the anode layer, and a plurality of electrolyte layers. The electrolyte layers are provided between the cathode layer and the bipolar electrode layer, and between the anode layer and the bipolar electrode layer. The bipolar electrode layer includes a bipolar electrode current collector, a cathode active material layer that is provided on one face of the bipolar electrode current collector, and an anode active material layer that is provided on the other face of the bipolar electrode current collector. In the bipolar electrode current collector, a first current collector, an adhesive resin layer that has a through hole, and a second current collector, are laminated in this order. The first current collector and the second current collector are bonded to each other via the adhesive resin layer.

Japanese Unexamined Patent Application Publication No. 2013-077734 (JP 2013-077734 A) discloses an electrode. The electrode has a metal foil having a plurality of through holes, and an active material layer that is coated on one face or both faces of the metal foil. The active material layer includes an active material that is made of a carbonaceous material that is capable of absorbing and desorbing lithium ions, and also, a surface roughness Rz of the active material layer is no less than 1 μm and no more than 20 μm.

WO 2024/053312 discloses a power storage device. The power storage device includes a stacked body including bipolar electrodes that are stacked, and an encapsulating member that seals the stacked body. The bipolar electrode has a current collector that includes a first main surface and a second main surface that is opposite to the first main surface, a first active material layer that is provided on the first main surface, and a second active material layer that is provided on the second main surface. The current collector has a first metal foil that includes the first main surface, a second metal foil that includes the second main surface and that is thinner than the first metal foil, and a conductive adhesive layer that is provided between the first metal foil and the second metal foil so as to bond the first metal foil and the second metal foil to each other. The conductive adhesive layer is thinner than the second metal foil.

### SUMMARY

There is room for improvement bipolar batteries, in terms of energy density.

An object of the present disclosure is to provide a current collector for a bipolar battery, which is capable of improving energy density of batteries, and a bipolar battery having such a current collector.

The present disclosers found that the above issue can be solved by the following means.

### First Aspect

A current collector for a bipolar battery, in which
a first current collector and a second current collector are bonded via a conductive adhesive layer,
a first through hole is provided in the first current collector, and the conductive adhesive layer enters into the first through hole, and, or alternatively,
a second through hole is provided in the second current collector, and the conductive adhesive layer enters into the second through hole.

### Second Aspect

The current collector according to the First Aspect, in which the first through hole and the second through hole are provided.

### Third Aspect

The current collector according to the Second Aspect, in which the first through hole and the second through hole are not provided at positions facing each other in a laminating direction.

### Fourth Aspect

The current collector according to any one of the First to Third Aspects, in which
in a plane direction, a proportion of a total area of the first through hole to a total area of the first current collector is no less than 10% and no more than 50%, and, or alternatively,
in the plane direction, a proportion of a total area of the second through hole to a total area of the second current collector is no less than 10% and no more than 50%.

### Fifth Aspect

A bipolar battery, including
a first electrode active material layer, a current collector according to any one of the First to Fourth Aspects, and a second electrode active material layer, in this order, in which
the first electrode active material layer is bonded to the current collector by the conductive adhesive layer entering into the first through hole, and, or alternatively,
the second electrode active material layer is bonded to the current collector by the conductive adhesive layer entering into the second through hole.

According to the present disclosure, a current collector for a bipolar battery that is capable of improving energy density of batteries, and a bipolar battery having the current collector, can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view showing an example of a current collector for a bipolar battery of the present disclosure;

FIG. 2A is a schematic cross-sectional view illustrating an example of a current collector for a bipolar battery according to an embodiment of the present disclosure.

FIG. 2B is a schematic cross-sectional view illustrating an example of a current collector for a bipolar battery according to an embodiment of the present disclosure.

FIG. 3 is a schematic cross-sectional view showing an example of a current collector for a bipolar battery of the present disclosure;

FIG. 4A is a schematic plan view of a current collector for a bipolar battery according to an embodiment of the present disclosure;

FIG. 4B is a schematic plan view of a current collector for a bipolar battery according to an embodiment of the present disclosure;

FIG. 5 is a schematic cross-sectional view illustrating an exemplary bipolar battery of the present disclosure; and

FIG. 6 is a schematic cross-sectional view showing an example of a current collector for a bipolar battery according to the prior art.

### DETAILED DESCRIPTION OF EMBODIMENTS

Hereinafter, embodiments of the present disclosure will be described in detail. It should be noted that the present disclosure is not limited to the following embodiments, and various modifications can be made within the scope of the gist of the disclosure.

### Current Collector for Bipolar Battery

In the current collector for a bipolar battery of the present disclosure, the first current collector and the second current collector are bonded to each other via a conductive adhesive layer. A first through hole is provided in the first current collector, and the conductive adhesive layer penetrates into the first through hole. And/or, the second current collector is provided with a second through hole, and the conductive adhesive layer penetrates into the second through hole.

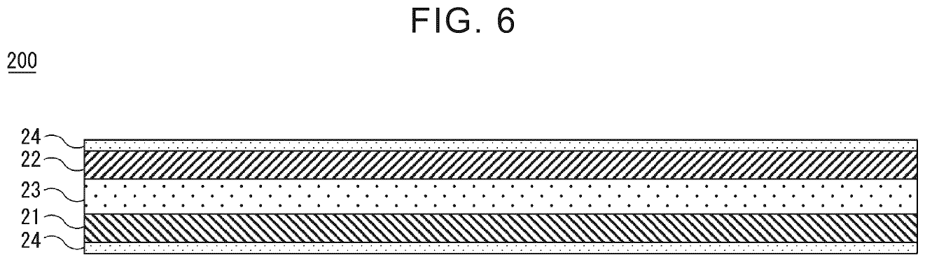

In the bipolar battery, in order to bond the electrode active material layer and the current collector, it is conceivable to provide the outer conductive adhesive layer 24 on the outside of the first current collector 21 and the second current collector 22 as illustrated in FIG. 6. However, in this case, the thickness of the battery increases by the amount of the outer conductive adhesive layer 24, and as a result, the energy density decreases.

In the Disclosing Party, a through hole is provided in either or both of the first and second current collectors. A conductive adhesive layer interposed between the first and second current collectors penetrates into the through hole. As a result, it has been found that the electrode active material layer can be adhered to the current collector for a bipolar battery by the conductive adhesive layer that has entered at least one of the through holes. As a result, it has been found that the thickness of the bipolar battery can be reduced and thus the energy density of the battery can be improved as compared with the case where the outer conductive adhesive layer is provided between the first and second current collectors and the electrode active material layer.

Further, in the battery using the current collector for a bipolar battery of the present disclosure, the current collector and the electrode active material layer are in direct contact with each other. Therefore, it is considered that the resistance at the interface between the current collector and the electrode active material layer can be reduced as compared with the case where the outer conductive adhesive layer is provided between the current collector and the electrode active material layer.

Hereinafter, elements constituting the current collector for a bipolar battery of the present disclosure will be described with reference to the drawings. The dimensional relationship in the drawings does not reflect the actual dimensional relationship.

### First Current Collector and Second Current Collector

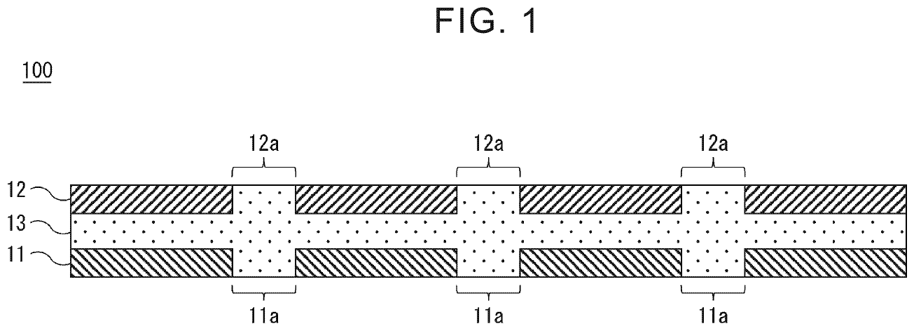

As illustrated in FIGS. 1 to 3, the first current collector 11 and the second current collector 12 are bonded to each other via the conductive adhesive layer 13 and function as a current collector for a bipolar battery.

The first and second current collectors are not particularly limited. For example, when the battery using the current collector for a bipolar battery of the present disclosure is a lithium ion secondary battery, the first and second current collectors may be copper foil, copper alloy foil, nickel foil, aluminum foil, aluminum alloy foil, stainless steel foil, carbon sheet, or the like. In particular, the first current collector and the first current collector may be different. That is, for example, an anode active material layer as the first electrode active material layer and a cathode active material layer as the second electrode active material layer are respectively disposed on the surface of the first current collector and the second current collector opposite to the surface of the first current collector on the side to be bonded by the conductive adhesive layer. In this case, the first current collector may be a copper foil and the second current collector may be an aluminum foil.

A carbon coat layer may be formed on the surface of the first and second current collectors on the side to be bonded by the conductive adhesive layer.

The thicknesses of the first and second current collectors are not particularly limited, but may be, for example, 10 μm or more and 150 μm or less.

The size of the first and second current collectors is not particularly limited as long as the size of the first and second through holes to be described later are provided.

### Conductive Adhesive Layer

As illustrated in FIGS. 1 to 3, the conductive adhesive layer 13 is interposed between the first current collector 11 and the second current collector 12 to adhere the first current collector 11 and the second current collector 12. The first and second current collectors bonded in this manner function as current collectors for bipolar batteries.

The conductive adhesive layers 13 enter the first through holes 11a and the second through holes 12a described later. Accordingly, the electrode active material layer can be adhered to the bipolar battery current collector 100 without providing an outer conductive adhesive layer between the first current collector and the electrode active material layer and at least one of the second current collector and the electrode active material layer.

The material of the conductive adhesive layer is not particularly limited. For example, the conductive adhesive layer may be composed of a mixture of an adhesive component and a conductive component.

Examples of the adhesive component include, but are not limited to, curable resins. Examples of the curable resin include a thermosetting resin and a photocurable resin. More specifically, examples of the curable resin include an olefinic resin and an acrylic resin.

The curable resin can be used in combination with a curing agent. The curing agent is not particularly limited, and a curing agent commonly used as a curing agent for a curable resin can be used. Examples of the curing agent include an isocyanate-based curing agent and an epoxy-based curing agent.

The conductive component is not particularly limited as long as the conductive component is higher than the adhesive component. For example, metal particles such as gold, silver, platinum, zinc, stainless steel, nickel, copper, cobalt, molybdenum, antimony, iron, and chromium; alloy particles such as aluminum-magnesium alloys, aluminum-nickel alloys, and so forth, metal oxide particles such as tin oxide and indium oxide; particles obtained by coating noble metals such as gold, silver, and platinum on metal particles such as nickel; and non-conductive particles such as glass, ceramic, and plastic particles coated with noble metals such as gold, silver, and platinum; carbon particles like graphites such as natural graphite and artificial graphite, acetylene black, Ketjen black, channel black, furnace black, lamp black, and thermal black.

The thickness of the conductive adhesive layer is not particularly limited, but may be, for example, 10 μm or more and 150 μm or less.

The size of the conductive adhesive layer is not particularly limited, but may be the same as the size of the first and second current collectors from the viewpoint of adhesion to the first and second current collectors.

### First Through Hole and Second Through Hole

As illustrated in FIGS. 1 to 3, in the current collector 100 for a bipolar battery of the present disclosure, the first current collector 11 is provided with a first through hole 11a, and/or the second current collector is provided with a second through hole 12a. That is, in the current collector for a bipolar battery of the present disclosure, the first through hole 11a and the second through hole 12a may be provided as described below:

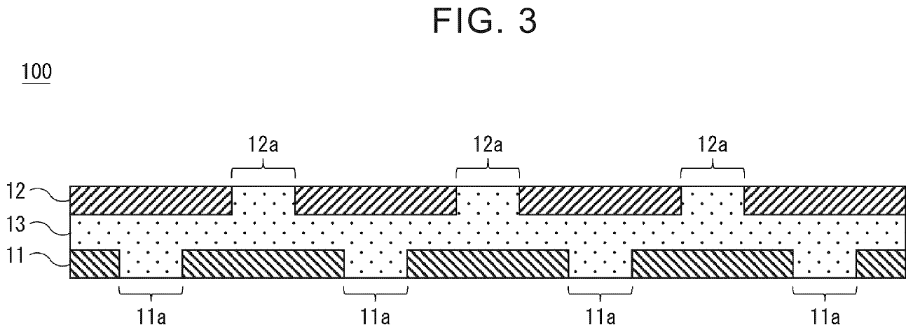

A first through hole 11a is provided in the first current collector 11, and a second through hole 12a is provided in the second current collector 12 (see FIGS. 1 and 3);

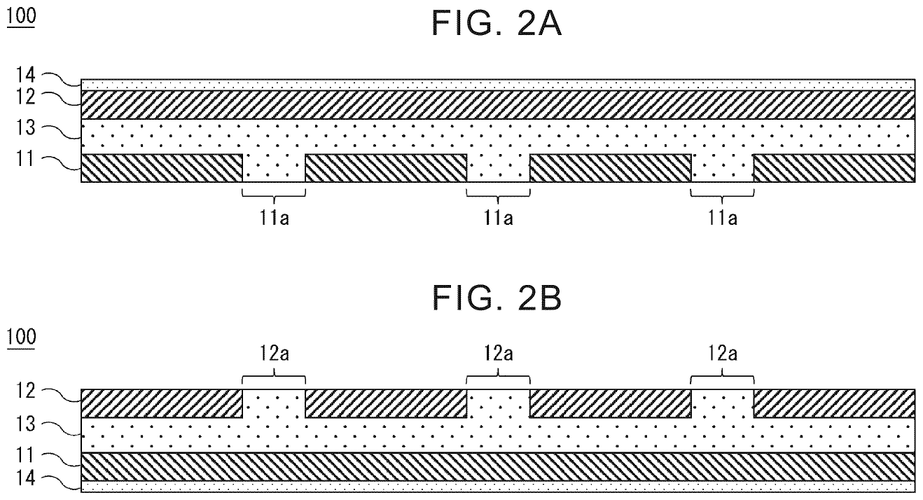

The first current collector 11 is provided with the first through hole 11a, but the second current collector 12 is not provided with the second through hole 12a (see FIG. 2A);
The first current collector 11 is not provided with the first through hole 11a, and the second current collector 12 is provided with the second through hole 12a (see FIG. 2B).

In particular, as illustrated in FIGS. 1 and 3, in the current collector for a bipolar battery of the present disclosure, first and second through holes may be provided. That is, a through hole may be provided in both the first current collector and the second current collector. With such a configuration, it is not necessary to provide the outer conductive adhesive layer between the first current collector and the electrode active material layer and between the second current collector and the electrode active material layer, and thus the energy density can be improved more effectively.

As illustrated in FIGS. 1 and 3, in the current collector 100 for a bipolar battery of the present disclosure, the first through hole 11a and the second through hole 12a may be provided at positions opposed to each other in the stacking direction (see FIG. 1). The first through hole 11a and the second through hole 12a may not be provided at positions opposed to each other (see FIG. 3). In the stacking direction, the first through hole 11a and the second through hole 12a are not provided at positions opposed to each other. As a result, unevenness in the internal resistance of the battery caused by the difference in the thickness of the conductive adhesive layer 13 can be reduced, and as a result, a non-uniform battery reaction can be suppressed. Note that “not provided at positions opposed to each other” means that the first through hole 11a and the second through hole 12a do not overlap each other in the stacking direction.

In the current collector 100 for a bipolar battery of the present disclosure, the ratio of the total area of the first through hole 11a to the total area of the first current collector 11 is not less than 10% and not more than 50%. And/or, the ratio of the total area of the second through hole 12a to the total area of the second current collector 12 may be 10% or more and 50% or less. With such a configuration, the electrode active material layer and the conductive adhesive layer can be favorably bonded to each other while ensuring the current collecting function of the current collector in which the through hole is appropriately formed and the through hole is provided.

As illustrated in FIGS. 2A and 2B, when any one of the first through hole 11a and the second through hole 12a is provided, the outer conductive adhesive layer 14 may be provided on the current collector on which the through hole is not provided. Accordingly, the current collector and the electrode active material layer can be bonded to each other even on the side where the through hole is not provided.

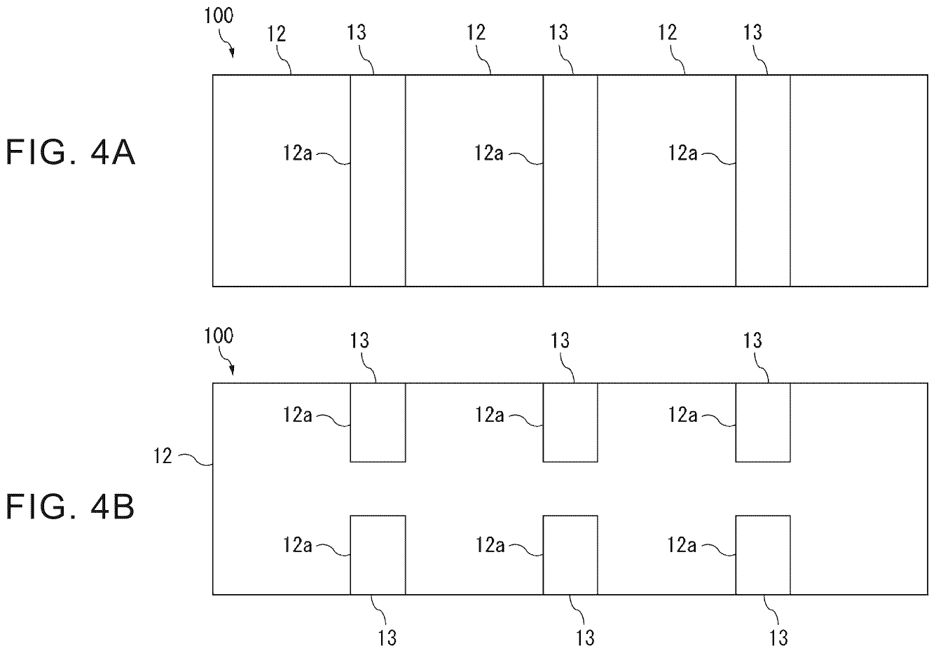

Here, FIGS. 4A and 4B are schematic plan views of the current collector 100 for a bipolar battery of the present disclosure in FIGS. 1, 2B, and 3 when viewed from the second current collector 12. From the viewpoint of reducing the unevenness of the inner resistivity of the batteries, as illustrated in FIGS. 4A and 4B, the second through hole 12a may be arranged so as to have less deviation in the plane of the second current collector 12. Specifically, the second through holes 12a provided at equal intervals may extend in the plane direction (see FIG. 4A) or may not extend in the plane direction (see FIG. 4B). As long as the conductive adhesive layer 13 can adhere the electrode active material layer, that is, the conductive adhesive layer 13 can enter the second through hole 12a, the planar shapes of the second through hole 12a are not limited to those illustrated in FIGS. 4A and 4B.

Although not shown, the first through hole 11a may also have a planar configuration similar to that of the second through hole 12a.

When both the first and second current collectors have through holes, the current collector for a bipolar battery of the present disclosure can be manufactured by, for example, a dry lamination method as shown below.

A curable resin is applied onto the first current collector (or the second current collector) and dried.

The first current collector (or the second current collector) is half-cut into a desired shape.

An unnecessary portion of the half-cut first current collector (or second current collector) is collected to form a first through hole (or second through hole).

The second current collector (or the first current collector) having a through hole formed in advance is bonded to the curable resin by thermocompression bonding or the like using a heating roller or the like.

### Bipolar Battery

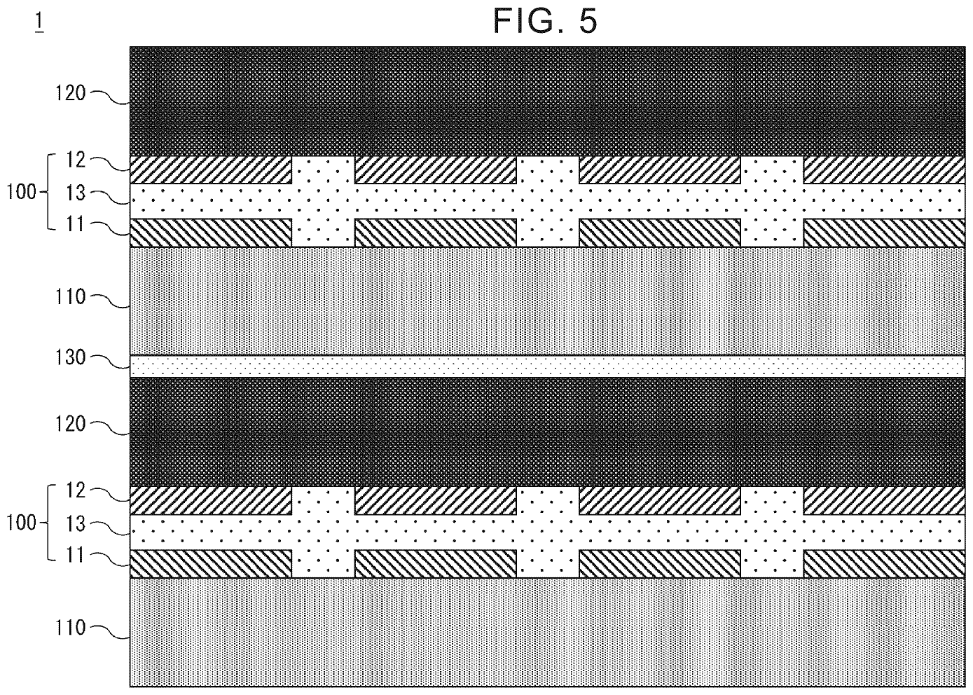

As illustrated in FIG. 5, the bipolar battery 1 of the present disclosure includes a first electrode active material layer 110, a current collector 100 for a bipolar battery of the present disclosure, and a second electrode active material layer 120 in this order. In the bipolar battery 1 of the present disclosure, the first electrode active material layer 110 is bonded to the bipolar battery current collector 100 by the conductive adhesive layer 13 that has entered the first through hole 11a. The second electrode active material layer 120 is bonded to the bipolar battery current collector 100 by the conductive adhesive layer 13 that has entered the second through hole 12a. In such a bipolar battery, it is not necessary to provide an outer conductive adhesive layer for bonding at least one electrode active material layer, and the energy density of the battery can be improved.

In particular, in the bipolar battery 1 of the present disclosure, the first electrode active material layer 110 is bonded to the bipolar battery current collector 100 by the conductive adhesive layer 13 that has entered the first through hole 11a. The second electrode active material layer 120 may be bonded to the bipolar battery current collector 100 by the conductive adhesive layer 13 that has entered the second through hole 12a. In such a bipolar battery, it is not necessary to provide an outer conductive adhesive layer for bonding both electrode active material layers, and the energy density of the battery can be improved more effectively.

In connection with the present disclosure, a laminate composed of the first electrode active material layer 110, the current collector 100 for a bipolar battery of the present disclosure, and the second electrode active material layer 120 may be referred to as a “bipolar electrode”.

The bipolar battery 1 of the present disclosure may further include an electrolyte layer 130 in addition to the bipolar electrode.

The bipolar battery 1 of the present disclosure may be configured by stacking a plurality of bipolar electrodes and an electrolyte layer 130. Although FIG. 5 illustrates the bipolar battery 1 including two bipolar electrodes and one electrolyte layer 130, the number of the bipolar electrodes and the electrolyte layer 130 is not limited thereto.

The bipolar battery of the present disclosure may be a secondary battery, particularly a lithium-ion secondary battery.

The bipolar battery of the present disclosure may be a liquid-based battery or a solid-state battery. In the context of the present disclosure, a “solid battery” means a battery using at least a solid electrolyte as an electrolyte, and therefore a solid battery may use a combination of a solid electrolyte and a liquid electrolyte as an electrolyte. The solid-state battery of the present disclosure may be an all-solid-state battery, that is, a battery using only a solid electrolyte as an electrolyte.

Hereinafter, elements constituting the bipolar battery of the present disclosure will be described.

### First Electrode Active Material Layer and Second Electrode Active Material Layer

In the bipolar battery 1 of the present disclosure, the first electrode active material layer 110 is disposed on the side of the first current collector 11, and the second electrode active material layer 120 is disposed on the side of the second current collector 12.

In the present disclosure, one of the first electrode active material layer 110 and the second electrode active material layer 120 may be an anode active material layer, and the other may be a cathode active material layer. That is, for example, when the first electrode active material layer is an anode active material layer, the second electrode active material layer may be a cathode active material layer, and when the first electrode active material layer is a cathode active material layer, the second electrode active material layer may be an anode active material layer.

For example, when the first electrode active material layer 110 is an anode active material layer and the second electrode active material layer 120 is a cathode active material layer, the first electrode active material layer may be formed of an anode mixture containing an anode active material and optionally containing a conductive auxiliary agent, a binder, and the like. The second electrode active material layer includes a cathode active material, and may optionally be formed of a cathode mixture including a conductive auxiliary agent, a binder, and the like.

In the context of the present disclosure, “mixture” means a composition that can constitute an electrode active material layer, either as it is or by further containing other components. Also, in the context of the present disclosure, a “mixture slurry” means a slurry that includes a dispersion medium in addition to a “mixture” and can be applied and dried to form an electrode active material layer.

### Negative Active Material

The anode active material is not particularly limited as long as it has a lower potential than that of the cathode active material. When the bipolar battery of the present disclosure is a lithium ion secondary battery, examples of the anode active material include carbonaceous material such as graphite, resin carbon fiber, carbon fiber, activated carbon, carbon soft carbon and so forth; metal-based materials of which tin, tin alloy, silicon, silicon alloy, gallium, gallium alloy, indium, indium alloy, aluminum, aluminum alloy, or the like is a primary component; conductive polymers such as polyacene, polyacetylene, polypyrrole; lithium complex oxides such as Li₄Ti₅O₁₂, lithium alloys such as Li—Si alloy, Li—Sn alloy, Li—Al alloy, Li—Ga alloy, Li—Mg alloy, Li—In alloy; and the like. These negative active substances may be used in one type alone or a combination of two or more types.

The content of the negative active material in the negative gating material may be more than 50% by mass, more than 70% by mass, more than 90% by mass, or more than 95% by mass.

### Cathode Active Material

The shape of the anode active material may be, for example, particulate.

The cathode active material is not particularly limited as long as it has a noble potential as compared with the anode active material. When the bipolar battery of the present disclosure is a lithium ion secondary cell, for example, complex oxides such as lithium cobaltate (LiCoO₂), lithium nickelate (LiNiO₂), lithium manganate (LiMn₂O₄), solid solution oxide (Li₂MnO₃—LiMO₂ (M=Co, Ni, etc.)), nickel lithium manganate (LiNi_{1/2}Mn_{1/2}O₂), nickel lithium cobalt manganate (LiNi_{1/3}Mn_{1/3}Co_{1/3}O₂), and olivine-type lithium phosphate (LiFePO₄); conductive polymers such as polyaniline, polypyrrole; Li₂S, CuS, Li—Cu—S compounds, TiS₂, FeS, MoS₂, Li—Mo—S compounds, Li—Ti—S compounds, Li—V—S compounds and like sulfide-based cathode active materials; acetylene black impregnated with sulfur, porous carbon impregnated with sulfur, material obtained by using sulfur such as a mixed powder of sulfur and carbon as an active material, and so forth, can be used as the cathode active material. These cathode active materials may be used singly or in a combination of two or more.

The content of the positive polar active substance in the positive gating material may be more than 50% by mass, 70% by mass, more than 90% by mass, or more than 95% by mass.

The shape of the cathode active material may be, for example, particulate.

### Conductive Aid

Examples of the conductive auxiliary agent include, but are not limited to, graphites such as natural graphite and artificial graphite; carbon blacks such as acetylene black, Ketjen black, channel black, furnace black, lamp black, and thermal black; conductive fibers such as carbon fibers like carbon nanotubes, metal fibers, and so forth; metal powders such as aluminum powder; conductive whiskers such as zinc oxide whiskers and conductive potassium titanate whiskers; conductive metal oxides such as titanium oxide; organic conductive materials such as phenylene derivatives; and the like. These conduction aids may be used in one single type or a combination of two or more types.

The content of the conductive auxiliary agent in the anode mixture and the cathode mixture is not particularly limited, and can be appropriately set in accordance with desired conductivity or the like.

### Binder

Examples of the binder include, but are not limited to, polyvinylidene fluoride (PVdF), polytetrafluoroethylene, polyethylene, polypropylene, aramid resin, polyamide, polyimide, polyamideimide, polyvinyl alcohol, polyacrylonitrile, polyacrylic acid, methyl polyacrylate, ethyl polyacrylate, hexyl polyacrylate, polymethacrylic acid, methyl polymethacrylate, ethyl polymethacrylate, hexyl polymethacrylate, polyvinyl acetate, polyvinyl pyrrolidone, polyether, polyether sulfone, polyhexafluoropropylene, styrene butadiene rubber, and carboxymethyl cellulose. These binders may be used singly or in a combination of two or more.

The content of the conductive auxiliary agent in the anode mixture and the cathode mixture is not particularly limited, and can be appropriately set according to a desired binding property or the like.

In the context of the present disclosure, bipolar electrodes can be produced, for example, by the following method:
A first (or second) electrode mixture slurry is prepared by adding a solvent to the first (or second) electrode mixture and mixing, and the slurry is applied to one side of a current collector for a bipolar battery using an applicator or the like and dried to form a first (or second) electrode active material layer;
A second (or first) electrode mixture slurry is prepared by adding a solvent to the second (or first) electrode mixture and mixing the same, and the slurry is applied to the other side of the current collector for a bipolar battery using an applicator or the like and dried to form a second (or first) electrode active material layer to obtain a laminate;
The resulting laminate is pressurized by roll pressing or the like while applying a predetermined load.

### Electrolyte Layer

The electrolyte layer 130 may be disposed between the first electrode active material layer 110 and the second electrode active material layer 120. The electrolyte layer may be a porous separator impregnated with a non-aqueous electrolyte solution, a solid electrolyte layer including a solid electrolyte, or a combination thereof.

As the porous separator, the first electrode active material layer and the second electrode active material layer are electrically insulated from each other, and the bipolar battery of the present disclosure is a lithium ion secondary battery. In this case, there is no particular limitation as long as it has a function of transmitting lithium ions. As the porous separator, for example, a porous membrane can be used. Examples of the porous film include a microporous polymer film, and examples of the material include polyolefin, polyimide, polyvinylidene fluoride, and polyester.

The non-aqueous electrolyte solution is a solution obtained by dissolving an electrolyte in a solvent. As the electrolyte, any known lithium salt can be used, and may be selected according to the type of the active material. For example, LiClO₄, LiBF₄, LiPF₆, LiCF₃SO₃, LiCF₃CO₂, LiAsF₆, LiSbF₆, LiB₁₀Cl₁₀, LiAlCl₄, LiCl, LiBr, LiB(C₂H₅)₄, CF₃SO₃Li, CH₃SO₃Li, LiCF₃SO₃, LiC₄F₉SO₃, Li(CF₃SO₂)₂N, lithium lower fatty acid carboxylate, and the like.

The solvent for dissolving the electrolyte is not particularly limited as long as it is usually used as a liquid for dissolving the electrolyte. Examples thereof include carbonates such as ethylene carbonate (EC), propylene carbonate (PC), butylene carbonate (BC), dimethyl carbonate (DMC), diethyl carbonate (DEC), methyl ethyl carbonate (MEC), and vinylene carbonate (VC); lactones such as γ-butyrolactone and γ-valerolactone; ethers such as trimethoxymethane, 1,2-dimethoxyethane, diethyl ether, 2-ethoxyethane, tetrahydrofuran, and 2-methyltetrahydrofuran; sulfoxides such as dimethyl sulfoxide; oxolanes such as 1,3-dioxolane, 4-methyl-1,3-dioxolane; nitrogen-containing esters such as acetonitrile, nitromethane, formamide, and dimethylformamide; organic esters such as methyl formate, ethyl acetate, butyl acetate, methyl propionate and ethyl propionate; phosphate triesters and diglymes; triglymes; sulfolanes such as sulfolane and methylsulfolane; oxazolidinones such as 3-methyl-2-oxazolidinone; sultones such as 1,3-propanesultone, 1,4-butanesultone and naphthasultone; and the like. These may be used singly or in a combination of two or more.

The solid electrolyte constituting the solid electrolyte layer is not particularly limited. When the bipolar battery of the present disclosure is a lithium ion secondary battery, for example, an inorganic solid electrolyte such as a sulfide-based solid electrolyte, an oxide-based solid electrolyte, or other lithium-based inorganic solid electrolyte; and an organic solid electrolyte such as a polymer electrolyte can be exemplified.

As the sulfide-based solid electrolyte, for example, Li₂S—P₂S₅, Li₂S—SiS₂, Li₂S—GeS₂, Li₂S—Al₂S₃, Li₂S—SiS₂—Li₃PO₄, Li₂S—P₂S₅—GeS₂, Li₂S—Li₂O—P₂S₅—SiS₂, Li₂S—GeS₂—P₂S₅—SiS₂, Li₂S—SnS₂—P₂S₅—SiS₂, and the like. These may be used singly or in a combination of two or more.

Examples of the oxide-based solid electrolyte include LiTi₂(PO₄)₃, LiZr₂(PO₄)₃, LiGe₂(PO₄)₃. and like NASICON types, and perovskite types such as (La_{0.5+x}Li_{0.5-3x}) TiO₃.

Other examples of the lithium-based inorganic solid-state electrolyte include LiPON, LiNbO₃, LiTaO₃, Li₃PO₄, LiPO₄₋ₓNₓ (where x is 0<x≤1), LiN, LiI, LISICON, and the like.

Further, glass ceramics obtained by depositing crystals of these inorganic solid electrolytes can also be used as the solid electrolyte.

As the organic solid electrolyte, for example, a polymer electrolyte such as a dry polymer electrolyte or a gel electrolyte can be used. As the polymer electrolyte, one generally used in a lithium-ion battery can be used.

The shape of the solid electrolyte may be, for example, particulate.

### Other ingredients

The first and second electrode active material layers may contain components other than those described above. Examples of such components include dispersants. Examples of the dispersant include carboxymethylcellulose.

The content of the other components in the anode mixture or the cathode mixture is not particularly limited, and can be appropriately set according to desired characteristics.

What is claimed is:

1. A current collector for a bipolar battery, wherein
a first current collector and a second current collector are bonded via a conductive adhesive layer,
a first through hole is provided in the first current collector, and the conductive adhesive layer enters into the first through hole, and, or alternatively,
a second through hole is provided in the second current collector, and the conductive adhesive layer enters into the second through hole.

2. The current collector according to claim 1, wherein the first through hole and the second through hole are provided.

3. The current collector according to claim 2, wherein the first through hole and the second through hole are not provided at positions facing each other in a laminating direction.

4. The current collector according to claim 1, wherein,
in a plane direction, a proportion of a total area of the first through hole to a total area of the first current collector is no less than 10% and no more than 50%, and, or alternatively,
in the plane direction, a proportion of a total area of the second through hole to a total area of the second current collector is no less than 10% and no more than 50%.

5. A bipolar battery, comprising:
a first electrode active material layer; a current collector according to claim 1; and a second electrode active material layer, in an order of the first electrode active material layer, the current collector, and the second electrode active material layer, wherein
the first electrode active material layer is bonded to the current collector by the conductive adhesive layer entering into the first through hole, and, or alternatively,
the second electrode active material layer is bonded to the current collector by the conductive adhesive layer entering into the second through hole.
